(19) United States
(12) Patent Application Publication
(10) Pub. No.: US 2026/0222877 A1
(43) Pub. Date: Jul. 30, 2026

(54) LOWER LAYER TRIGGERED MOBILITY IN A WIRELESS COMMUNICATION NETWORK

(71) Applicant: Nokia Technologies Oy, Espoo (FI)

(72) Inventors: Umur KARABULUT, Munich (DE); Panagiotis SPAPIS, Munich (DE); Jedrzej STANCZAK, Wroclaw (PL); Chitradeep MAJUMDAR, Bangalore (IN); Srinivasan SELVAGANAPATHY, Bangalore (IN); Sanjay GOYAL, Murray Hill, NJ (US)

(21) Appl. No.: 19/148,478

(22) PCT Filed: Mar. 4, 2024
(86) PCT No.: PCT/EP2024/055586

§ 371 Date: Jul. 16, 2025

(30) Foreign Application Priority Data
Apr. 6, 2023 (IN) 202341026092

(51) Int. Cl. H04W 24/10; H04B 7/06; H04W 36/00

(52) U.S. Cl. CPC H04W 24/10; H04B 7/06952; H04W 36/0072

(57) ABSTRACT

A user equipment for connecting towards a Radio Access Network, comprising: at least one processor; and at least one memory storing instruction which, when executed by the at least one processor, cause the user equipment at least to: establish a connection with a first network node that supports at least one of the distributed unit functionality or a Layer (2) protocol of the Radio Access Network via a first cell supported by the first network node; receive, from the Radio Access Network, a configuration message to perform Layer (1) measurements for at least one candidate target cell with which the user equipment may connect, and an indication to enable identification of at least one specific candidate target cell for which a Layer (1) measurement shall be included in at least one of the associated Layer (1) measurements reports; perform the configured Layer (1) measurements and evaluate for which candidate cell a respective Layer (1) measurement is to be included in a respective Layer (1) measurement report based on the at least one indicated specific candidate target cell; and generate and transmit the respective Layer (1) measurement report towards the first network node.

### TECHNOLOGICAL FIELD

Various example embodiments relate to wireless telecommunication networks, and more particularly, to facilitating mobility within such wireless telecommunication networks.

### BACKGROUND

As user equipment (UE) moves through a wireless telecommunication network, it may move through cells that comprise regions of radio coverage that are supported by one or more network access node. Maintaining an ability for a UE to communicate effectively with the wireless communication system as it moves through regions of radio coverage is typically referred to as mobility. Layer 1 (L1) or Layer 2 (L2), sometimes termed lower layer, triggered mobility is being increasingly considered to reduce the latency, overhead and interruption time associated with a UE moving between the different cells.

### BRIEF SUMMARY

The scope of protection sought for various example embodiments of the invention is set out by the independent claims. The example embodiments and features, if any, described in this specification that do not fall under the scope of the independent claims are to be interpreted as examples useful for understanding various embodiments of the invention.

According to various, but not necessarily all, example embodiments of the invention there is provided a user equipment for connecting towards a Radio Access Network, comprising: at least one processor; and at least one memory storing instruction which, when executed by the at least one processor, cause the user equipment at least to: establish a connection with a first network node that supports at least one of the distributed unit functionality or a Layer 2 protocol of the Radio Access Network via a first cell supported by the first network node; receive, from the Radio Access Network, a configuration message to perform Layer 1 measurements for at least one candidate target cell with which the user equipment may connect, and an indication to enable identification of at least one specific candidate target cell for which a Layer 1 measurement shall be included in at least one of the associated Layer 1 measurements reports; perform the configured Layer 1 measurements and evaluate for which candidate cell a respective Layer 1 measurement is to be included in a respective Layer 1 measurement report based on the at least one indicated specific candidate target cell; and generate and transmit the respective Layer 1 measurement report towards the first network node.

The configuration message may include at least one evaluation criteria to select a cell as the at least one indicated specific candidate cell for which a Layer 1 measurement is to be reported.

The configuration message may include at least one evaluation criteria to select in case of two specific cells at least the best of the two is to be reported.

The configuration message may include at least one evaluation criteria to select as the at least one indicated specific candidate cell a candidate target cell for which a Timing Advance information for a potential connection between the user equipment and the determined candidate target cell is available.

The instructions, when executed by the at least one processor, may cause the user equipment at least to: receive, from the Radio Access Network, a message to trigger an acquisition of a Timing Advance information for at least one candidate target cell with which the user equipment may connect.

The instructions, when executed by the at least one processor, may cause the user equipment at least to: determine for at least one of the candidate target cells whether Timing Advance information for a potential connection between the user equipment and the determined candidate target cell is available.

The Timing Advance information may be based on information received from the first network node and/or from a target network node in response to the triggered Timing Advance acquisition.

The instructions, when executed by the at least one processor, may cause the user equipment at least to: classify a candidate target cell for which Timing Advance information is available as a synchronised cell and a candidate target cell for which Timing Advance information is not available as a non-synchronised cell.

The instructions, when executed by the at least one processor, may cause the user equipment at least to: generate and transmit the at least one Layer 1 Measurement Report having at least one measurement value of associated with a synchronised cell and at least one measurement value of associated with a non-synchronised cell.

The configuration message may include at least one evaluation criteria to select a number of measurement values associated with synchronised cells and a number of measurement values associated with non-synchronised cells to be included in Layer 1 Measurement Reports and wherein the instructions, when executed by the at least one processor, may cause the user equipment at least to: generate and transmit at least one Layer 1 Measurement Report having the number of measurement values associated with synchronised cells and the number of measurement values associated with non-synchronised cells.

The configuration message may include at least one evaluation criteria to select a minimum number of measurement values associated with synchronised cells to be included in Layer 1 Measurement Reports and wherein the instructions, when executed by the at least one processor, may cause the user equipment at least to: generate and transmit at least one Layer 1 Measurement Report having the minimum number of measurement values associated with synchronised cells.

The configuration message may include at least one evaluation criteria to select a minimum number of measurement values associated with non-synchronised cells to be included in Layer 1 Measurement Reports and wherein the instructions, when executed by the at least one processor, may cause the user equipment at least to: generate and transmit at least one Layer 1 Measurement Report having the minimum number of measurement values associated with non-synchronised cells.

The configuration message may include at least one evaluation criteria to select a ratio of measurement values associated with synchronised cells with respect to measurement values associated with non-synchronised cells to be included in Layer 1 Measurement Reports and wherein the instructions, when executed by the at least one processor, may cause the user equipment at least to: generate and transmit at least one Layer 1 Measurement Report having measurement values in accordance with the ratio.

The Layer 1 Measurement Report may carry M measurement values and the configuration message may include at least one evaluation criteria to select the user equipment to provide Layer 1 Measurement Reports having S measurement values of synchronised cells and N measurement values of non-synchronised cells, where S≥N and (S+N)≤M and wherein the instructions, when executed by the at least one processor, may cause the user equipment at least to: generate and transmit at least one Layer 1 Measurement Report having S measurement values of synchronised cells and N measurement values of non-synchronised cells, where S≥N or S<N and (S+N)≤M, and where S≥0, N≥0 and M≥1.

The configuration message may configure the user equipment to generate and transmit measurement values of synchronised cells and non-synchronised cells over successive Layer 1 Measurement Reports.

The measurement values may comprise beam measurements of at least one candidate target cell and the instructions, when executed by the at least one processor, may cause the user equipment at least to: identify a signal strength of beam measurements made at the user equipment associated with synchronised cells and non-synchronised cells and generate and transmit at least one Layer 1 Measurement Report having at least one beam measurement value of a strongest signal strength synchronised cell and at least one beam measurement value of a strongest signal strength non-synchronised cell.

The instructions, when executed by the at least one processor, may cause the user equipment at least to: transmit at least one Layer 1 Measurement Report having at least one beam measurement value of a strongest signal strength synchronised cell even when weaker than beam measurement values of non-synchronised cells.

The network node may comprise at least one of or supports functionality of at least one of: a base station, a 5G gNB, a Centralised Unit, a Distributed Unit, a secondary node, a source node or a source secondary node.

The configuration message may comprise at least one of a Radio Resource Configuration message and a Medium Access Control Control Element message.

According to various, but not necessarily all, example embodiments of the invention there is provided a user equipment for connecting towards a Radio Access Network, comprising: means for establishing a connection with a first network node that supports at least one of the distributed unit functionality or a Layer 2 protocol of the Radio Access Network via a first cell supported by the first network node; means for receiving, from the Radio Access Network, a configuration message to perform Layer 1 measurements for at least one candidate target cell with which the user equipment may connect, and an indication to enable identification of at least one specific candidate target cell for which a Layer 1 measurement shall be included in at least one of the associated Layer 1 measurements reports; means for performing the configured Layer 1 measurements and evaluate for which candidate cell a respective Layer 1 measurement is to be included in a respective Layer 1 measurement report based on the at least one indicated specific candidate target cell; and means for generating and transmitting the respective Layer 1 measurement report towards the first network node.

The means may perform the optional features set out in relation to the apparatus mentioned above.

According to various, but not necessarily all, example embodiments of the invention there is provided a user equipment for connecting towards a Radio Access Network, comprising: circuitry configured to establish a connection with a first network node that supports at least one of the distributed unit functionality or a Layer 2 protocol of the Radio Access Network via a first cell supported by the first network node; circuitry configured to receive, from the Radio Access Network, a configuration message to perform Layer 1 measurements for at least one candidate target cell with which the user equipment may connect, and an indication to enable identification of at least one specific candidate target cell for which a Layer 1 measurement shall be included in at least one of the associated Layer 1 measurements reports; circuitry configured to perform the configured Layer 1 measurements and evaluate for which candidate cell a respective Layer 1 measurement is to be included in a respective Layer 1 measurement report based on the at least one indicated specific candidate target cell; and circuitry configured to generate and transmit the respective Layer 1 measurement report towards the first network node.

The circuitry may be configured perform the optional features set out in relation to the apparatus mentioned above.

According to various, but not necessarily all, example embodiments of the invention there is provided a method equipment for connecting towards a Radio Access Network, comprising: establishing a connection with a first network node that supports at least one of the distributed unit functionality or a Layer 2 protocol of the Radio Access Network via a first cell supported by the first network node; receiving, from the Radio Access Network, a configuration message to perform Layer 1 measurements for at least one candidate target cell with which the user equipment may connect, and an indication to enable identification of at least one specific candidate target cell for which a Layer 1 measurement shall be included in at least one of the associated Layer 1 measurements reports; performing the configured Layer 1 measurements and evaluate for which candidate cell a respective Layer 1 measurement is to be included in a respective Layer 1 measurement report based on the at least one indicated specific candidate target cell; and generating and transmitting the respective Layer 1 measurement report towards the first network node.

The configuration message may include at least one evaluation criteria to select a cell as the at least one indicated specific candidate cell for which a Layer 1 measurement is to be reported.

The configuration message may include at least one evaluation criteria to select in case of two specific cells at least the best of the two is to be reported.

The configuration message may include at least one evaluation criteria to select as the at least one indicated specific candidate cell a candidate target cell for which a Timing Advance information for a potential connection between the user equipment and the determined candidate target cell is available.

The method may comprise: receiving, from the Radio Access Network, a message to trigger an acquisition of a Timing Advance information for at least one candidate target cell with which the user equipment may connect.

The method may comprise: determining for at least one of the candidate target cells whether Timing Advance information for a potential connection between the user equipment and the determined candidate target cell is available.

The Timing Advance information may be based on information received from the first network node and/or from a target network node in response to the triggered Timing Advance acquisition.

The method may comprise: classifying a candidate target cell for which Timing Advance information is available as a synchronised cell and a candidate target cell for which Timing Advance information is not available as a non-synchronised cell.

The method may comprise: generating and transmitting the at least one Layer 1 Measurement Report having at least one measurement value of associated with a synchronised cell and at least one measurement value of associated with a non-synchronised cell.

The configuration message may include at least one evaluation criteria to select a number of measurement values associated with synchronised cells and a number of measurement values associated with non-synchronised cells to be included in Layer 1 Measurement Reports and the method may comprise: generating and transmitting at least one Layer 1 Measurement Report having the number of measurement values associated with synchronised cells and the number of measurement values associated with non-synchronised cells.

The configuration message may include at least one evaluation criteria to select a minimum number of measurement values associated with synchronised cells to be included in Layer 1 Measurement Reports and the method may comprise: generating and transmitting at least one Layer 1 Measurement Report having the minimum number of measurement values associated with synchronised cells.

The configuration message may include at least one evaluation criteria to select a minimum number of measurement values associated with non-synchronised cells to be included in Layer 1 Measurement Reports and the method may comprise: generating and transmitting at least one Layer 1 Measurement Report having the minimum number of measurement values associated with non-synchronised cells.

The configuration message may include at least one evaluation criteria to select a ratio of measurement values associated with synchronised cells with respect to measurement values associated with non-synchronised cells to be included in Layer 1 Measurement Reports and the method may comprise: generating and transmitting at least one Layer 1 Measurement Report having measurement values in accordance with the ratio.

The Layer 1 Measurement Report may carry M measurement values and the configuration message may include at least one evaluation criteria to select the user equipment to provide Layer 1 Measurement Reports having S measurement values of synchronised cells and N measurement values of non-synchronised cells, where S≥N and (S+N)≤M and the method may comprise: generating and transmitting at least one Layer 1 Measurement Report having S measurement values of synchronised cells and N measurement values of non-synchronised cells, where S≥N or S<N and (S+N)≤M, and where S≥0, N≥0 and M≥1.

The configuration message may configure the user equipment to generate and transmit measurement values of synchronised cells and non-synchronised cells over successive Layer 1 Measurement Reports.

The measurement values may comprise beam measurements of at least one candidate target cell, and the method may comprise: identifying a signal strength of beam measurements made at the user equipment associated with synchronised cells and non-synchronised cells and generating and transmitting at least one Layer 1 Measurement Report having at least one beam measurement value of a strongest signal strength synchronised cell and at least one beam measurement value of a strongest signal strength non-synchronised cell.

The method may comprise: transmitting at least one Layer 1 Measurement Report having at least one beam measurement value of a strongest signal strength synchronised cell even when weaker than beam measurement values of non-synchronised cells.

The network node may comprise at least one of or supports functionality of at least one of: a base station, a 5G gNB, a Centralised Unit, a Distributed Unit, a secondary node, a source node or a source secondary node.

The configuration message may comprise at least one of a Radio Resource Configuration message and a Medium Access Control Control Element message.

According to various, but not necessarily all, example embodiments of the invention there is provided a non-transitory computer readable medium comprising program instructions stored thereon for performing at least the following: establishing a connection with a first network node that supports at least one of the distributed unit functionality or a Layer 2 protocol of the Radio Access Network via a first cell supported by the first network node; receiving, from the Radio Access Network, a configuration message to perform Layer 1 measurements for at least one candidate target cell with which the user equipment may connect, and an indication to enable identification of at least one specific candidate target cell for which a Layer 1 measurement shall be included in at least one of the associated Layer 1 measurements reports; performing the configured Layer 1 measurements and evaluate for which candidate cell a respective Layer 1 measurement is to be included in a respective Layer 1 measurement report based on the at least one indicated specific candidate target cell; and generating and transmitting the respective Layer 1 measurement report towards the first network node.

The instructions may be for performing the optional features set out in relation to the method mentioned above.

According to various, but not necessarily all, example embodiments of the invention there is provided a network node of a Radio Access Network, comprising: at least one processor; and at least one memory storing instruction which, when executed by the at least one processor, cause the network node at least to: support at least one of distributed unit functionality or a Layer 2 protocol of the Radio Access Network via a first cell to establish a connection with a user equipment; transmit, from the Radio Access Network, a configuration message to perform Layer 1 measurements for at least one candidate target cell with which the user equipment may connect, and an indication to enable identification of at least one specific candidate target cell for which a Layer 1 measurement shall be included in at least one of the associated Layer 1 measurements reports; and receive the respective Layer 1 measurement report from the user equipment.

The configuration message may include at least one evaluation criteria to select a cell as the at least one indicated specific candidate cell for which a Layer 1 measurement is to be reported.

The configuration message may include at least one evaluation criteria to select in case of two specific cells at least the best of the two is to be reported.

The configuration message may include at least one evaluation criteria to select as the at least one indicated specific candidate cell a candidate target cell for which a Timing Advance information for a potential connection between the user equipment and the determined candidate target cell is available.

The instructions, when executed by the at least one processor, may cause the network node at least to: transmit, to the user equipment, a message to trigger an acquisition of a Timing Advance information for at least one candidate target cell with which the user equipment may connect.

The Timing Advance information may be based on information transmitted from the network node and/or from a target network node in response to the triggered Timing Advance acquisition.

The instructions, when executed by the at least one processor, may cause the network node at least to: classify a candidate target cell for which Timing Advance information is available as a synchronised cell and a candidate target cell for which Timing Advance information is not available as a non-synchronised cell.

The instructions, when executed by the at least one processor, may cause the network node at least to: receive the at least one Layer 1 Measurement Report having at least one measurement value of associated with a synchronised cell and at least one measurement value of associated with a non-synchronised cell.

The configuration message may include at least one evaluation criteria to select a number of measurement values associated with synchronised cells and a number of measurement values associated with non-synchronised cells to be included in Layer 1 Measurement Reports and wherein the instructions, when executed by the at least one processor, may cause the network node at least to: receive at least one Layer 1 Measurement Report having the number of measurement values associated with synchronised cells and the number of measurement values associated with non-synchronised cells.

The configuration message may include at least one evaluation criteria to select a minimum number of measurement values associated with synchronised cells to be included in Layer 1 Measurement Reports and wherein the instructions, when executed by the at least one processor, may cause the network node at least to: receive at least one Layer 1 Measurement Report having the minimum number of measurement values associated with synchronised cells.

The configuration message may include at least one evaluation criteria to select a minimum number of measurement values associated with non-synchronised cells to be included in Layer 1 Measurement Reports and wherein the instructions, when executed by the at least one processor, may cause the network node at least to: receive at least one Layer 1 Measurement Report having the minimum number of measurement values associated with non-synchronised cells.

The configuration message may include at least one evaluation criteria to select a ratio of measurement values associated with synchronised cells with respect to measurement values associated with non-synchronised cells to be included in Layer 1 Measurement Reports and wherein the instructions, when executed by the at least one processor, may cause the network node at least to: receive at least one Layer 1 Measurement Report having measurement values in accordance with the ratio.

The Layer 1 Measurement Report may carry M measurement values and the configuration message may include at least one evaluation criteria to select the user equipment to provide Layer 1 Measurement Reports having S measurement values of synchronised cells and N measurement values of non-synchronised cells, where S≥N and (S+N)≤M and wherein the instructions, when executed by the at least one processor, may cause the network node at least to: receive at least one Layer 1 Measurement Report having S measurement values of synchronised cells and N measurement values of non-synchronised cells, where S≥N or S<N and (S+N)≤M, and where S≥0, N≥0 and M≥1.

The configuration message may configure the user equipment to generate and transmit measurement values of synchronised cells and non-synchronised cells over successive Layer 1 Measurement Reports.

The measurement values may comprise beam measurements of at least one candidate target cell and the instructions, when executed by the at least one processor, may cause the network node at least to: receive at least one Layer 1 Measurement Report having at least one beam measurement value of a strongest signal strength synchronised cell and at least one beam measurement value of a strongest signal strength non-synchronised cell.

The instructions, when executed by the at least one processor, may cause the network node at least to: receive at least one Layer 1 Measurement Report having at least one beam measurement value of a strongest signal strength synchronised cell even when weaker than beam measurement values of non-synchronised cells.

The network node may comprise at least one of or supports functionality of at least one of: a base station, a 5G gNB, a Centralised Unit, a Distributed Unit, a secondary node, a source node or a source secondary node.

The configuration message may comprise at least one of a Radio Resource Configuration message and a Medium Access Control Control Element message.

According to various, but not necessarily all, example embodiments of the invention there is provided a network node of a Radio Access Network, comprising: means for supporting at least one of distributed unit functionality or a Layer 2 protocol of the Radio Access Network via a first cell to establish a connection with a user equipment; means for transmitting, from the Radio Access Network, a configuration message to perform Layer 1 measurements for at least one candidate target cell with which the user equipment may connect, and an indication to enable identification of at least one specific candidate target cell for which a Layer 1 measurement shall be included in at least one of the associated Layer 1 measurements reports; and means for receiving the respective Layer 1 measurement report from the user equipment.

The means may perform the optional features set out in relation to the apparatus mentioned above.

According to various, but not necessarily all, example embodiments of the invention there is provided a network node of a Radio Access Network, comprising: circuitry configured to support at least one of distributed unit functionality or a Layer 2 protocol of the Radio Access Network via a first cell to establish a connection with a user equipment; circuitry configured to transmit, from the Radio Access Network, a configuration message to perform Layer 1 measurements for at least one candidate target cell with which the user equipment may connect, and an indication to enable identification of at least one specific candidate target cell for which a Layer 1 measurement shall be included in at least one of the associated Layer 1 measurements reports; and circuitry configured to receive the respective Layer 1 measurement report from the user equipment.

The circuitry may be configured perform the optional features set out in relation to the apparatus mentioned above.

According to various, but not necessarily all, example embodiments of the invention there is provided a method, comprising: supporting at least one of distributed unit functionality or a Layer 2 protocol of a Radio Access Network via a first cell to establish a connection with a user equipment; transmitting, from the Radio Access Network, a configuration message to perform Layer 1 measurements for at least one candidate target cell with which the user equipment may connect, and an indication to enable identification of at least one specific candidate target cell for which a Layer 1 measurement shall be included in at least one of the associated Layer 1 measurements reports; and receiving the respective Layer 1 measurement report from the user equipment.

The configuration message may include at least one evaluation criteria to select a cell as the at least one indicated specific candidate cell for which a Layer 1 measurement is to be reported.

The configuration message may include at least one evaluation criteria to select in case of two specific cells at least the best of the two is to be reported.

The configuration message may include at least one evaluation criteria to select as the at least one indicated specific candidate cell a candidate target cell for which a Timing Advance information for a potential connection between the user equipment and the determined candidate target cell is available.

The method may comprise: transmitting, to the user equipment, a message to trigger an acquisition of a Timing Advance information for at least one candidate target cell with which the user equipment may connect.

The Timing Advance information may be based on information transmitted from the network node and/or from a target network node in response to the triggered Timing Advance acquisition.

The method may comprise: classifying a candidate target cell for which Timing Advance information is available as a synchronised cell and a candidate target cell for which Timing Advance information is not available as a non-synchronised cell.

The method may comprise: receiving the at least one Layer 1 Measurement Report having at least one measurement value of associated with a synchronised cell and at least one measurement value of associated with a non-synchronised cell.

The configuration message may include at least one evaluation criteria to select a number of measurement values associated with synchronised cells and a number of measurement values associated with non-synchronised cells to be included in Layer 1 Measurement Reports and wherein the method may comprise: receiving at least one Layer 1 Measurement Report having the number of measurement values associated with synchronised cells and the number of measurement values associated with non-synchronised cells.

The configuration message may include at least one evaluation criteria to select a minimum number of measurement values associated with synchronised cells to be included in Layer 1 Measurement Reports and wherein the method may comprise: receiving at least one Layer 1 Measurement Report having the minimum number of measurement values associated with synchronised cells.

The configuration message may include at least one evaluation criteria to select a minimum number of measurement values associated with non-synchronised cells to be included in Layer 1 Measurement Reports and wherein the method may comprise: receiving at least one Layer 1 Measurement Report having the minimum number of measurement values associated with non-synchronised cells.

The configuration message may include at least one evaluation criteria to select a ratio of measurement values associated with synchronised cells with respect to measurement values associated with non-synchronised cells to be included in Layer 1 Measurement Reports and wherein the method may comprise: receiving at least one Layer 1 Measurement Report having measurement values in accordance with the ratio.

The Layer 1 Measurement Report may carry M measurement values and the configuration message includes at least one evaluation criteria to select the user equipment to provide Layer 1 Measurement Reports having S measurement values of synchronised cells and N measurement values of non-synchronised cells, where S≥N and (S+N)≤M and wherein the method comprises: receive at least one Layer 1 Measurement Report having S measurement values of synchronised cells and N measurement values of non-synchronised cells, where S≥N or S<N and (S+N)≤M, and where S≥0, N≥0 and M≥1.

The configuration message may configure the user equipment to generate and transmit measurement values of synchronised cells and non-synchronised cells over successive Layer 1 Measurement Reports.

The measurement values may comprise beam measurements of at least one candidate target cell and wherein the method comprises: receiving at least one Layer 1 Measurement Report having at least one beam measurement value of a strongest signal strength synchronised cell and at least one beam measurement value of a strongest signal strength non-synchronised cell.

The method may comprise: receiving at least one Layer 1 Measurement Report having at least one beam measurement value of a strongest signal strength synchronised cell even when weaker than beam measurement values of non-synchronised cells.

The network node may comprise at least one of or supports functionality of at least one of: a base station, a 5G gNB, a Centralised Unit, a Distributed Unit, a secondary node, a source node or a source secondary node.

The configuration message may comprise at least one of a Radio Resource Configuration message and a Medium Access Control Control Element message.

According to various, but not necessarily all, example embodiments of the invention there is provided a non-transitory computer readable medium comprising program instructions stored thereon for performing at least the following: supporting at least one of distributed unit functionality or a Layer 2 protocol of a Radio Access Network via a first cell to establish a connection with a user equipment; transmitting, from the Radio Access Network, a configuration message to perform Layer 1 measurements for at least one candidate target cell with which the user equipment may connect, and an indication to enable identification of at least one specific candidate target cell for which a Layer 1 measurement shall be included in at least one of the associated Layer 1 measurements reports; and receiving the respective Layer 1 measurement report from the user equipment.

The instructions may be for performing the optional features set out in relation to the method mentioned above.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

### BRIEF DESCRIPTION

Some example embodiments will now be described with reference to the accompanying drawings in which:

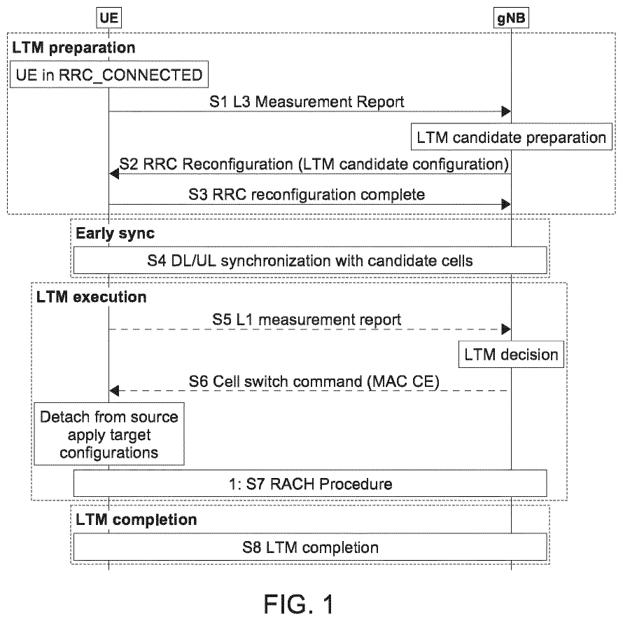

FIG. 1 illustrates a messaging sequence chart for L1/L2 Triggered Mobility (LTM);

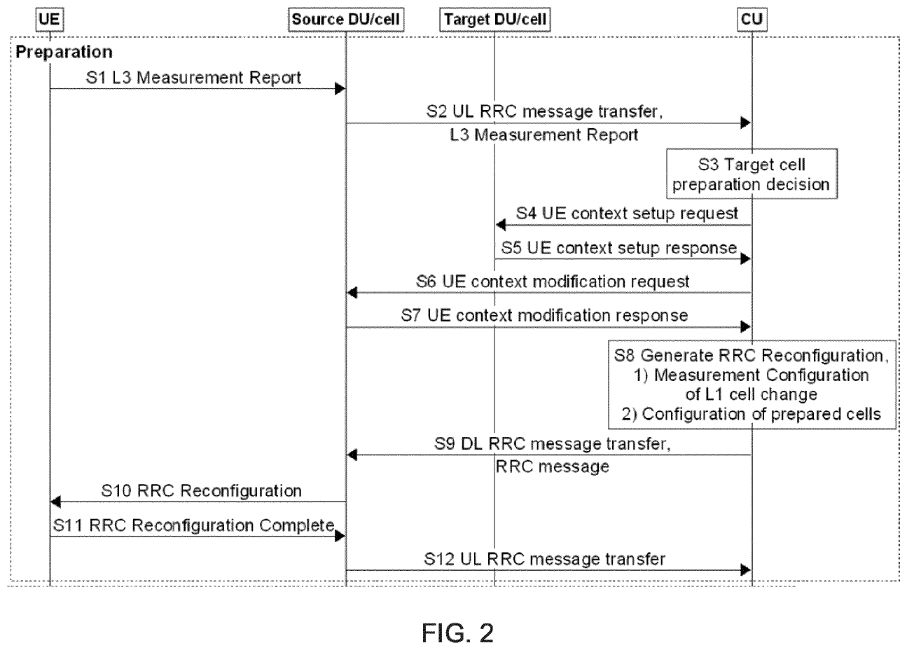

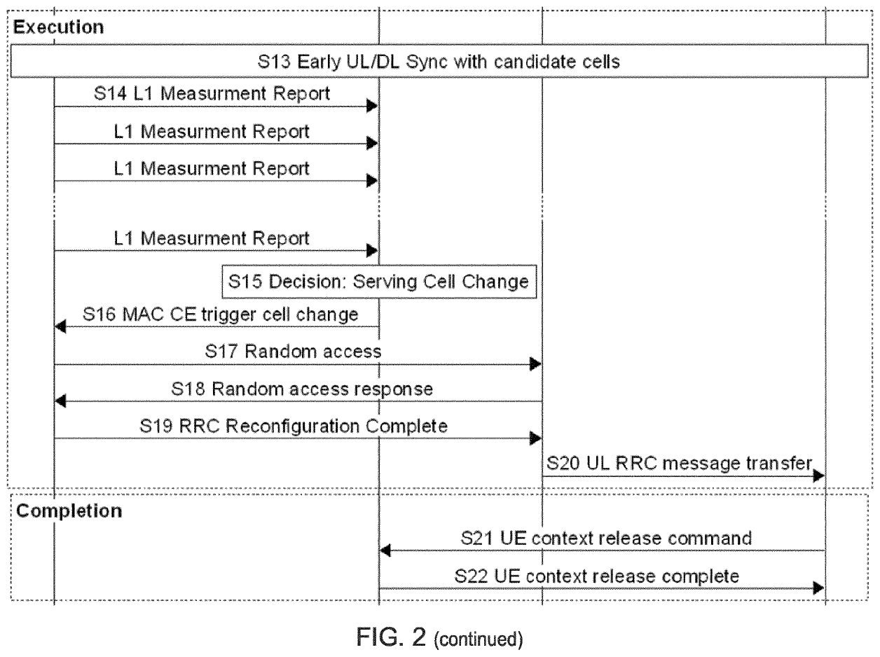

FIG. 2 illustrates a messaging sequence chart for L1/L2 Triggered Mobility Framework for a Central Unit (CU)-Distributed Unit (DU) split architecture;

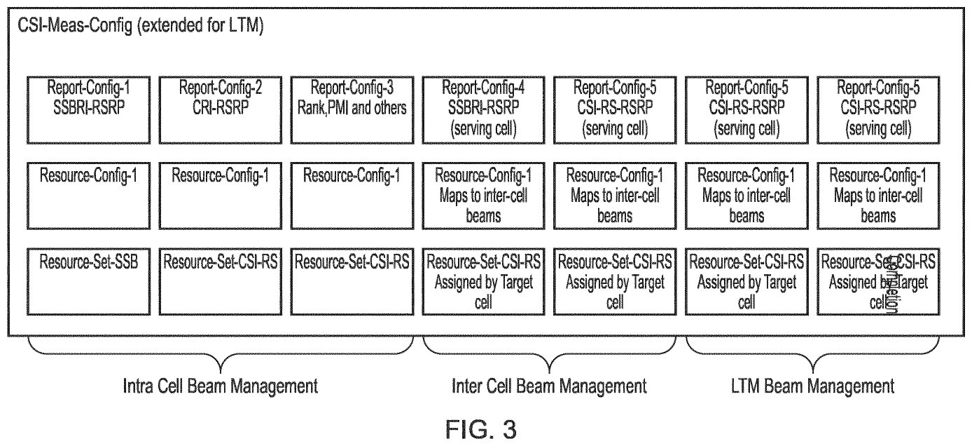

FIG. 3 illustrates a L1 Beam Measurement and Reporting configuration structure (extended for LTM Beam Management);

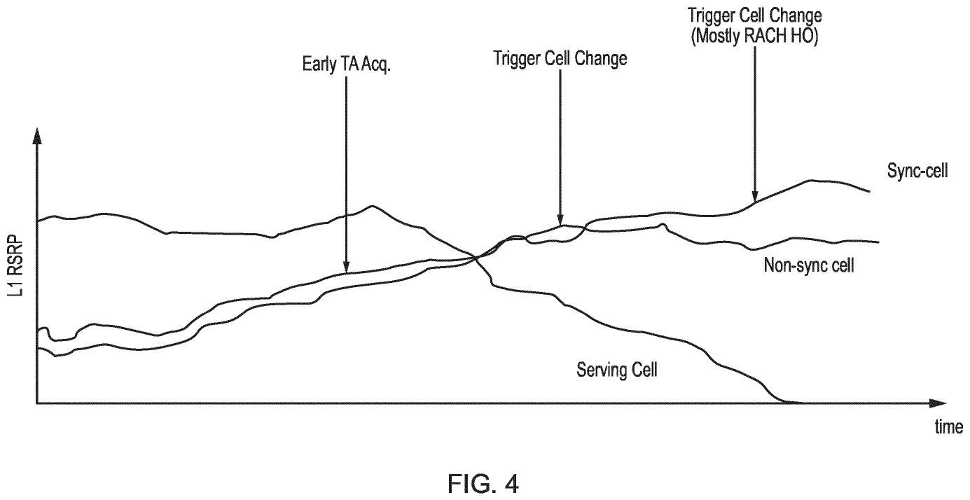

FIG. 4 illustrates L1 RSRP measurements performed by the UE for serving cell and target cells; and

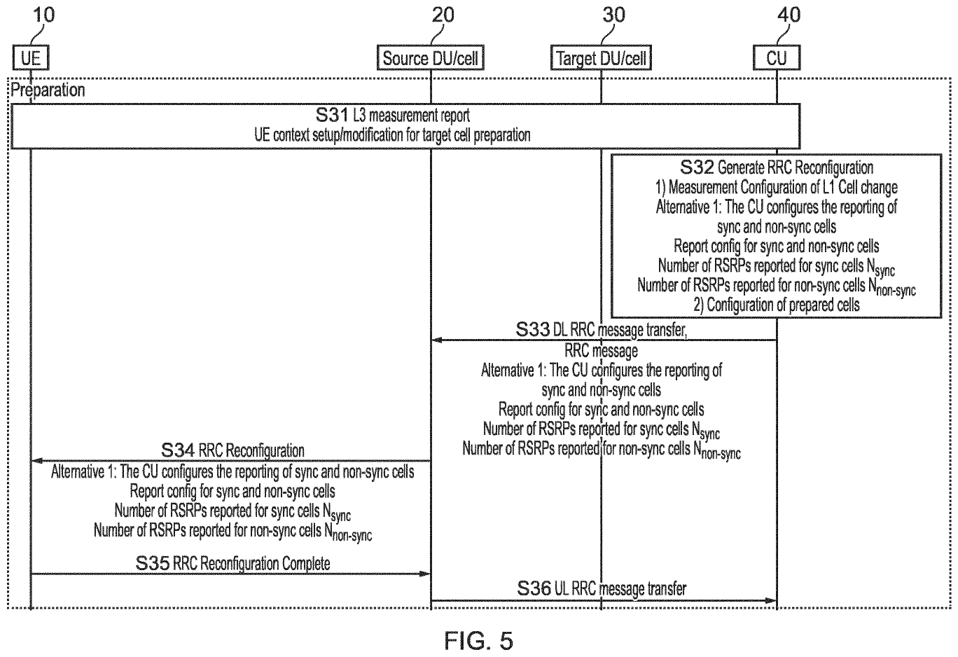

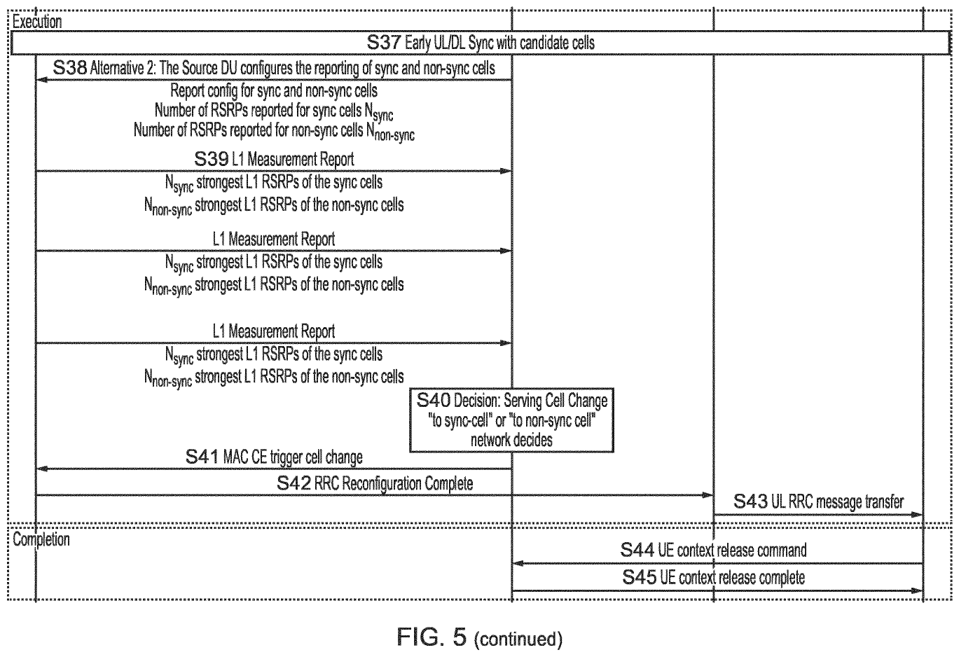

FIG. 5 illustrates a messaging sequence chart according to one example embodiment.

### DETAILED DESCRIPTION

Before discussing the example embodiments in any more detail, first an overview will be provided. Some example embodiments provide an arrangement for providing measurement reports of candidate target cells which reduce interruption when connecting to those candidate target cells. Unlike in current Layer 1 measurement reports where only the strongest (those with the highest received power) beams are reported, the user equipment is instead configured to provide measurements of other candidate target cells, even if those are not the strongest. In particular, the user equipment is configured to provide measurements of target candidate cells which have a valid timing advance (so-called sync cells) even when those are not the strongest.

Typically, the allocation of measurements between sync and non-sync cells that can be carried by the measurement report(s) is configured in the user equipment. This gives the option of connecting to those sync cells where suitable to do so which can help to reduce interruption that would otherwise occur when connecting to other than a sync cell.

### L1/L2 Triggered Mobility (LTM) Framework (38.300 CR) [R2-2300375]

FIG. 1 shows an exemplary message sequence chart (MSC) for Layer 1 (L1)/Layer 2 (L2) triggered mobility (LTM) based on the change request (CR) [R2-2300375] on the LTM framework.

In steps S1 to S3: the Central Unit (CU) prepares target cells for LTM; the CU provides the LTM configuration for the prepared target cells; the CU also configures the UE with L1 measurement reporting needed for LTM execution.

In step S4, the UE performs early Uplink (UL)/Downlink (DL) synchronization with the candidate target cells to minimize the interruption during LTM execution.

In steps S5 to S6, the UE sends the L1 beam measurements of the target cells and the source DU decides on which cell the UE should handover (HO).

In case the Timing Advance (TA) of the target cell is still valid (from step S4), the UE skips the RACH procedure (step S7) during HO.

### L1/L2 Triggered Mobility Framework

The LTM framework defined in the running Change Request (CR) (38.300) does not elaborate the details of the split architecture as the technical specification of TS 38.300 only covers the RAN Overall descriptions. The internal view on the LTM framework for split architecture will now be explained. FIG. 2 shows an exemplary MSC for L1/L2 triggered mobility (LTM).

In steps S1 to S12: the CU prepares the target cells for LTM; the CU provides the LTM configuration for prepared cells; the CU also configures UE with L1 measurement reporting needed for LTM execution.

In step S13, the UE performs early UL/DL sync with candidate cells to minimize the interruption during LTM execution.

In steps S14 to S16, the UE sends the L1 beam measurements of the target cells and the source DU decides on which cell the UE should handover.

In case the TA of the target cell is still valid (from step S13), the UE skips the RACH procedure (steps S17 and S18) during HO.

### Periodic L1 Beam Measurements Channel State Information (CSI-ReportConfig)

### CSI-ReportConfig and CSI-MeasConfig

A maximum of 48 CSI reporting configurations can be provided to the UE (as per maxNrofCSI-ReportConfigurations) and the UE can be configured to measure up to 192 CSI individual Reference Signals (RSs). In LTM it is assumed that the UE can be configured to measure on multiple candidate cells (e.g. up to 8, the number is not yet decided-Stage-3 detail). The UE can be configured to report periodically, aperiodically or according to semi-persistent configuration. The UE can report up to 4 RS measurements in one L1 beam measurement (and expected to be 8).

FIG. 3 shows the existing L1 CSI MeasConfig structure that is used for intra-cell beam management (serving cell beams) and inter-cell beam management (non-serving cell beams) which are already in the Standard. The configuration may be extended for the LTM beam management procedure (the two right-most columns) to acquire the L1 beam measurements of the candidate cells. However, since the L1 measurements are reported in lower layers (from UE to DU), the amount of the measurements need to be configured economically (the number of RS measurements will be limited to 4, for each Report Config).

As mentioned above, the UE can send a limited number of L1 Reference Signal Received Power (RSRP) beam measurements in the L1 measurement report. The reported measurements may not include the measurements of a target cell for which the UE has a valid TA (sync-cell). This is because the content of the L1 measurement report can be dominated by beam measurements of another target cell for which the UE does not have a valid TA (non-sync-cell) even if the sync-cell measurements are good enough for handover. The issue is illustrated in FIG. 4 and in that case, the serving DU will typically perform one of the following: trigger the TA acquisition for the non-sync-cell—this leads interruption on both UL and DL and the risk of failure due to delayed HO procedure (TA acquisition takes time); trigger cell change to the non-sync-cell without TA acquisition—this leads interruption on UE side during cell change due to random access procedure; wait for one of the sync-cells to be reported in the L1 measurement report—this risks failure due to delayed HO procedure (the sync-cell may never be strongest but good enough to handover).

In the current L1 measurement reporting configuration and UE behaviour, when the UE is configured to report the L1 measurements, the UE reports the N strongest beam measurements that are measured at the UE side. The UE does not consider any criteria except the strength of the measurements. As explained below, due to the nature of L1 measurement fluctuations, this straightforward reporting criteria leads the network to miss the L1 measurement reports of some cells that are required on the network side for better cell switch decision (that considers the TA acquisition).

### Prioritising Measurements

In some example embodiments, a technique is proposed that configures UE to prioritize the reported L1 measurements of the cells against each other before reporting the L1 measurements. An aim of this prioritization technique is to prioritize the L1 reporting of the cell(s) with a valid TA (sync-cells) over reporting of the cell(s) without a valid TA (non-sync-cells). Hence, even if the L1 measurements of the non-sync cell(s) are strongest, the UE will report the L1 measurements of the sync-cell(s) with high priority.

CSI-Report-configuration which is mapped to LTM-CSI-Resources have a single Report configuration mapping to same PUCCH/PUSCH resources but with the option to multiplex them between TA maintained and non-TA cells across successive reports.

The report configuration may have static split to include for example, the Top-X (such as 2) TA-maintained and Top-Y (such as 2) TA non-maintained cells in case they are not same. This already allows at least the best TA-cell to be included in the report by excluding some lower strength non-TA-maintained cells. The ratio X:Y can be configurable such as, for example, 3:1 or 1:3 also. Here, the numerical examples are given for the case that the UE can report up to 4 beams in one L1 measurement report, but the ratios are applicable and adaptable to other numbers of beams that can be in the L1 measurement report.

In a first alternative (alternative 1), this can be configured by the CU when the LTM preparation configuration is generated at the CU. In a second alternative (alternative 2), the source DU configures the UE with a Medium Access Control (MAC) Control Element (CE) command to define the ratio of sync and non-sync cells to be reported. In either alternative 1 or 2, the MAC command (source DU) can control the ratio of TA and non-TA cells via single number of non-TA-cells to be included in the report.

The message sequence chart of an example embodiment is shown in FIG. 5.

In step S31: The UE 10 sends the L3 measurement report to the CU 40 and the CU 40 coordinates with the source and target DU 20, 30 to prepare the LTM configuration for target DU/cell(s).

In steps S32 to S34: The CU 40 generates the RRC Reconfiguration for LTM preparation. That includes the L1 measurement and reporting configuration that the UE 10 uses during the execution phase. In alternative 1, the CU 40 configures the reporting of sync and non-sync cells for L1 measurement report. Herein, the source CU 40 defines static numbers, one for sync cells N_{sync} and one for non-sync cells N_{non-sync}. The UE 10 will use those static numbers to decide how many RSRPs per sync cells and per non-sync cells to be reported in one L1 RSRP report. Then, this configuration is delivered to the UE 10 via source DU 20.

In step S37, the UE 10 acquires the TA of the target cell(s).
In the case that the UE 10 does not receive the TA of the target cells, i.e., the source DU 20 maintains the TA of the target cell and gives that TA to the UE 10 upon cell switch command (step S41), the source DU 20 indicates to the UE 10 which cells are sync and non-sync so that the UE 10 will decide on the reported L1 RSRPs with respect to the N_{sync} and N_{non-sync}.
In step S38, as alternative to steps S32 to S34, the source DU 20 determines the number of sync and non-sync cells to be reported in each L1 RSRP reports after step S37 (after the early sync is performed). Herein, as explained in step S37, the source DU 20 can also indicate to the UE 10 which cells are sync and non-sync so that the UE 10 will decide on the reported L1 RSRPs with respect to the N_{sync} and N_{non-sync}.

In step S39, the UE 10 will report the strongest N_{sync} L1 RSRPs for the cells with sync and the strongest N_{non-sync} L1 RSRPs for the cells with non-sync, all in one L1 Measurement report.

Hence, the source DU 20 will always receive the L1 RSRPs of both sync and non-sync cells.

In one example embodiment, a UE is pre-configured to report measurements on cells with (acquired and valid) TA. For example, a source DU selected a cell for early acquisition of TA (the selected cell is not always the strongest measured cell, but selection may depend on other criteria like load conditions, etc.), and once the UE receives e.g. a MAC CE to acquire TA for cell X, then this inherently is also a configuration/instruction to report L1 measurements on cell X (e.g. if TA acquisition was successful and as long as TA remains valid) e.g. even if they are not part of the max of for example N strongest beams which can be reported in a L1 report.

The following description may provide further details of alternatives, modifications and variances: a gNB comprises e.g., a node providing NR user plane and control plane protocol terminations towards the UE, and connected via the NG interface to the 5GC, e.g., according to 3GPP TS 38.300 V16.6.0 (2021 June) section 3.2 incorporated by reference. A gNB Central Unit (gNB-CU) comprises e.g., a logical node hosting e.g., RRC, SDAP and PDCP protocols of the gNB or RRC and PDCP protocols of the en-gNB that controls the operation of one or more gNB-DUs. The gNB-CU terminates the F1 interface connected with the gNB-DU. A gNB Distributed Unit (gNB-DU) comprises e.g., a logical node hosting e.g., RLC, MAC and PHY layers of the gNB or en-gNB, and its operation is partly controlled by the gNB-CU. One gNB-DU supports one or multiple cells. One cell is supported by only one gNB-DU. The gNB-DU terminates the F1 interface connected with the gNB-CU. A gNB-CU-Control Plane (gNB-CU-CP) comprises e.g., a logical node hosting e.g., the RRC and the control plane part of the PDCP protocol of the gNB-CU for an en-gNB or a gNB. The gNB-CU-CP terminates the E1 interface connected with the gNB-CU-UP and the F1-C interface connected with the gNB-DU. A gNB-CU-User Plane (gNB-CU-UP) comprises e.g., a logical node hosting e.g., the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U interface connected with the gNB-DU, e.g., according to 3GPP TS 38.401 V16.6.0 (2021 July) section 3.1 incorporated by reference.

Different functional splits between the central and distributed unit are possible, e.g., called options: Option 1 (1A-like split): The function split in this option is similar to the 1A architecture in DC. RRC is in the central unit. PDCP, RLC, MAC, physical layer and RF are in the distributed unit. Option 2 (3C-like split): The function split in this option is similar to the 3C architecture in DC. RRC and PDCP are in the central unit. RLC, MAC, physical layer and RF are in the distributed unit. Option 3 (intra RLC split): Low RLC (partial function of RLC), MAC, physical layer and RF are in the distributed unit. PDCP and high RLC (the other partial function of RLC) are in the central unit. Option 4 (RLC-MAC split): MAC, physical layer and RF are in the distributed unit. PDCP and RLC are in the central unit. Or else, e.g., according to 3GPP TR 38.801 V14.0.0 (2017 March) section 11 incorporated by reference.

A gNB supports different protocol layers, e.g., Layer 1 (L1)—physical layer.

The layer 2 (L2) of NR is split into the following sublayers: Medium Access Control (MAC), Radio Link Control (RLC), Packet Data Convergence Protocol (PDCP) and Service Data Adaptation Protocol (SDAP), where e.g.: The physical layer offers to the MAC sublayer transport channels; The MAC sublayer offers to the RLC sublayer logical channels; The RLC sublayer offers to the PDCP sublayer RLC channels; The PDCP sublayer offers to the SDAP sublayer radio bearers; The SDAP sublayer offers to 5GC QoS flows; Comp. refers to header compression and Segm. To segmentation; Control channels include (BCCH, PCCH).

Layer 3 (L3) includes e.g., Radio Resource Control (RRC), e.g., according to 3GPP TS 38.300 V16.6.0 (2021 June) section 6 incorporated by reference.

A RAN (Radio Access Network) node or network node like e.g. a gNB, base station, gNB CU or gNB DU or parts thereof may be implemented using e.g. an apparatus with at least one processor and/or at least one memory (with computer-readable instructions (computer program)) configured to support and/or provision and/or process CU and/or DU related functionality and/or features, and/or at least one protocol (sub-) layer of a RAN (Radio Access Network), e.g. layer 2 and/or layer 3.

The gNB CU and gNB DU parts may e.g., be co-located or physically separated. The gNB DU may even be split further, e.g., into two parts, e.g., one including processing equipment and one including an antenna. A Central Unit (CU) may also be called BBU/REC/RCC/C-RAN/V-RAN, O-RAN, or part thereof. A Distributed Unit (DU) may also be called RRH/RRU/RE/RU, or part thereof. Hereinafter, in various example embodiments of the present disclosure, the CU-CP (or more generically, the CU) may also be referred to as a (first) network node that supports at least one of central unit control plane functionality or a layer 3 protocol of a radio access network; and similarly, the DU may be referred to as a (second) network node that supports at least one of distributed unit functionality or the layer 2 protocol of the radio access network.

A gNB-DU supports one or multiple cells, and could thus serve as e.g., a serving cell for a user equipment (UE).

A user equipment (UE) may include a wireless or mobile device, an apparatus with a radio interface to interact with a RAN (Radio Access Network), a smartphone, an in-vehicle apparatus, an IoT device, a M2M device, or else. Such UE or apparatus may comprise: at least one processor; and at least one memory including computer program code; wherein the at least one memory and the computer program code are configured to, with the at least one processor, cause the apparatus at least to perform certain operations, like e.g. RRC connection to the RAN. A UE is e.g., configured to generate a message (e.g., including a cell ID) to be transmitted via radio towards a RAN (e.g., to reach and communicate with a serving cell). A UE may generate and transmit and receive RRC messages containing one or more RRC PDUs (Packet Data Units). The UE may have different states (e.g., according to 3GPP TS 38.331 V16.5.0 (2021 June) sections 42.1 and 4.4, incorporated by reference). A UE is e.g., either in RRC_CONNECTED state or in RRC_INACTIVE state when an RRC connection has been established. In RRC_CONNECTED state a UE may: store the AS context; transfer unicast data to/from the UE; monitor control channels associated with the shared data channel to determine if data is scheduled for the data channel; provide channel quality and feedback information; perform neighboring cell measurements and measurement reporting.

The RRC protocol includes e.g. the following main functions: RRC connection control; measurement configuration and reporting; establishment/modification/release of measurement configuration (e.g. intra-frequency, inter-frequency and inter-RAT measurements); setup and release of measurement gaps; measurement reporting.

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods. The term non-transitory as used herein, is a limitation of the medium itself (i.e., tangible, not a signal) as opposed to a limitation on data storage persistency (e.g. RAM vs ROM).

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Although example embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A user equipment for connecting towards a Radio Access Network, comprising:
at least one processor; and
at least one memory storing instruction which, when executed by the at least one processor, cause the user equipment at least to:
establish a connection with a first network node that supports at least one of the distributed unit functionality or a Layer 2 protocol of the Radio Access Network via a first cell supported by the first network node;
receive, from the Radio Access Network, a configuration message to perform Layer 1 measurements for at least one candidate target cell with which the user equipment may connect, and an indication to enable identification of at least one specific candidate target cell for which a Layer 1 measurement shall be included in at least one of the associated Layer 1 measurements reports;
perform the configured Layer 1 measurements and evaluate for which candidate cell a respective Layer 1 measurement is to be included in a respective Layer 1 measurement report based on the at least one indicated specific candidate target cell; and
generate and transmit the respective Layer 1 measurement report towards the first network node.

2. The user equipment of claim 1, wherein the configuration message includes:
at least one evaluation criteria to select a cell as the at least one indicated specific candidate cell for which a Layer 1 measurement is to be reported; and/or
at least one evaluation criteria to select in case of two specific cells at least the best of the two is to be reported; and/or
at least one evaluation criteria to select as the at least one indicated specific candidate cell a candidate target cell for which a Timing Advance information for a potential connection between the user equipment and the determined candidate target cell is available.

3. The user equipment of claim 1, wherein the instructions, when executed by the at least one processor, cause the user equipment at least to:
receive, from the Radio Access Network, a message to trigger an acquisition of a Timing Advance information for at least one candidate target cell with which the user equipment may connect; and/or
determine for at least one of the candidate target cells whether Timing Advance information for a potential connection between the user equipment and the determined candidate target cell is available.

4. The user equipment of claim 2, wherein the Timing Advance information is based on information received from the first network node and/or from a target network node in response to the triggered Timing Advance acquisition.

5. The user equipment of claim 2, wherein the instructions, when executed by the at least one processor, cause the user equipment at least to:
classify a candidate target cell for which Timing Advance information is available as a synchronised cell and a candidate target cell for which Timing Advance information is not available as a non-synchronised cell.

6. The user equipment of claim 5, wherein the instructions, when executed by the at least one processor, cause the user equipment at least to:
generate and transmit the at least one Layer 1 Measurement Report having at least one measurement value of associated with a synchronised cell and at least one measurement value of associated with a non-synchronised cell.

7. The user equipment of claim 5, wherein the configuration message includes at least one evaluation criteria to select a number of measurement values associated with synchronised cells and a number of measurement values associated with non-synchronised cells to be included in Layer 1 Measurement Reports and wherein the instructions, when executed by the at least one processor, cause the user equipment at least to:
generate and transmit at least one Layer 1 Measurement Report having the number of measurement values associated with synchronised cells and the number of measurement values associated with non-synchronised cells.

8. The user equipment of claim 5, wherein the configuration message includes at least one evaluation criteria to select a minimum number of measurement values associated with synchronised cells to be included in Layer 1 Measurement Reports and wherein the instructions, when executed by the at least one processor, cause the user equipment at least to:
generate and transmit at least one Layer 1 Measurement Report having the minimum number of measurement values associated with synchronised cells.

9. The user equipment of claim 5, wherein the configuration message includes at least one evaluation criteria to select a minimum number of measurement values associated with non-synchronised cells to be included in Layer 1 Measurement Reports and wherein the instructions, when executed by the at least one processor, cause the user equipment at least to:
generate and transmit at least one Layer 1 Measurement Report having the minimum number of measurement values associated with non-synchronised cells.

10. The user equipment of claim 5, wherein the configuration message includes at least one evaluation criteria to select a ratio of measurement values associated with synchronised cells with respect to measurement values associated with non-synchronised cells to be included in Layer 1 Measurement Reports and wherein the instructions, when executed by the at least one processor, cause the user equipment at least to:
generate and transmit at least one Layer 1 Measurement Report having measurement values in accordance with the ratio.

11. The user equipment of claim 5, wherein the Layer 1 Measurement Report carries M measurement values and the configuration message includes at least one evaluation criteria to select the user equipment to provide Layer 1 Measurement Reports having S measurement values of synchronised cells and N measurement values of non-synchronised cells, where S≥N and (S+N)≤M and wherein the instructions, when executed by the at least one processor, cause the user equipment at least to:
generate and transmit at least one Layer 1 Measurement Report having S measurement values of synchronised cells and N measurement values of non-synchronised cells, where S≥N or S<N and (S+N)≤M, and where S≥0, N≥0 and M≥1.

12. The user equipment of claim 5, wherein the configuration message configures the user equipment to generate and transmit measurement values of synchronised cells and non-synchronised cells over successive Layer 1 Measurement Reports.

13. The user equipment of claim 5, wherein the measurement values comprise beam measurements of at least one candidate target cell and the instructions, when executed by the at least one processor, cause the user equipment at least to:
identify a signal strength of beam measurements made at the user equipment associated with synchronised cells and non-synchronised cells and generate and transmit at least one Layer 1 Measurement Report having at least one beam measurement value of a strongest signal strength synchronised cell and at least one beam measurement value of a strongest signal strength non-synchronised cell.

14. The user equipment of claim 5, wherein the instructions, when executed by the at least one processor, cause the user equipment at least to:
transmit at least one Layer 1 Measurement Report having at least one beam measurement value of a strongest signal strength synchronised cell even when weaker than beam measurement values of non-synchronised cells.

15. The user equipment of claim 1, wherein the network node comprises at least one of or supports functionality of at least one of: a base station, a 5G gNB, a Centralised Unit, a Distributed Unit, a secondary node, a source node or a source secondary node.

16. The user equipment of claim 1, wherein the configuration message comprises at least one of a Radio Resource Configuration message and a Medium Access Control Control Element message.

17. A method for connecting towards a Radio Access Network, comprising:
establishing a connection with a first network node that supports at least one of the distributed unit functionality or a Layer 2 protocol of the Radio Access Network via a first cell supported by the first network node;
receiving, from the Radio Access Network, a configuration message to perform Layer 1 measurements for at least one candidate target cell with which the user equipment may connect, and an indication to enable identification of at least one specific candidate target cell for which a Layer 1 measurement shall be included in at least one of the associated Layer 1 measurements reports;
performing the configured Layer 1 measurements and evaluate for which candidate cell a respective Layer 1 measurement is to be included in a respective Layer 1 measurement report based on the at least one indicated specific candidate target cell; and
generating and transmitting the respective Layer 1 measurement report towards the first network node.

18. A network node for a Radio Access Network, comprising:
at least one processor; and
at least one memory storing instruction which, when executed by the at least one processor, cause the network node at least to:
support at least one of distributed unit functionality or a Layer 2 protocol of the Radio Access Network via a first cell to establish a connection with a user equipment;
transmit, from the Radio Access Network, a configuration message to perform Layer 1 measurements for at least one candidate target cell with which the user equipment may connect, and an indication to enable identification of at least one specific candidate target cell for which a Layer 1 measurement shall be included in at least one of the associated Layer 1 measurements reports; and
receive the respective Layer 1 measurement report from the user equipment.

19. The network node of claim 18, wherein the configuration message includes:
at least one evaluation criteria to select a cell as the at least one indicated specific candidate cell for which a Layer 1 measurement is to be reported; and/or
at least one evaluation criteria to select in case of two specific cells at least the best of the two is to be reported; and/or
at least one evaluation criteria to select as the at least one indicated specific candidate cell a candidate target cell for which a Timing Advance information for a potential connection between the user equipment and the determined candidate target cell is available.

20. The network node of claim 18, wherein the instructions, when executed by the at least one processor, cause the network node at least to:
transmit, to the user equipment, a message to trigger an acquisition of a Timing Advance information for at least one candidate target cell with which the user equipment may connect.

21.-34. (canceled)
